(19) United States
(12) Patent Application Publication
(10) Pub. No.: US 2017/0193537 A1
(43) Pub. Date: Jul. 6, 2017

(54) CREATION OF RICH PERSONAE

(71) Applicant: INTERNATIONAL BUSINESS MACHINES CORPORATION, ARMONK, NY (US)

(72) Inventor: Daniel M. Gruen, Cambridge, MA (US)

(21) Appl. No.: 14/984,820

(22) Filed: Dec. 30, 2015

(51) Int. Cl. G06Q 30/02

(52) U.S. Cl. CPC G06Q 30/0204

(57) ABSTRACT

A computer segments market demographic data into a plurality of market segments using statistical clustering techniques based on demographic descriptions. Each market segment is characterized by a plurality of parameters. Ranges or values for each of the plurality of parameters in a persona template are determined for people in the market segment. Each persona template is associated with a plurality of parameters that characterize the market segment represented by the persona. Specific values of the plurality of parameters are assigned to the persona template that describe a specific, sufficiently representative persona and the specific values of the plurality of parameters are checked consistency with each other.

### TECHNICAL FIELD

Embodiments of the present disclosure are directed to a method for creating a rich persona and more specifically to using computer implemented algorithms to select information consistent with the persona.

### BACKGROUND

There are many challenges associated with designing a marketing campaign or a product. A more compelling experience may be created by using persona. A persona is a fictional character created to represent the different user types that might use a site, brand, or product in a similar way. By focusing on a fictional user designers may create an experience more tailored to their desired user. The challenge to a designer is creating a persona with a rich background that reflects the desired user.

The use of personae has become commonplace as a design and product-development technique, enabling designers to envision how their offering will be used and provide value to their intended users. To be effective, a relatively small set of personae should be created, spread out so as to adequately cover the space of target users. In addition, to be effective, personae should describe people who are realistic and richly fleshed out with personal details, description and life story; including such things as location, occupation, age, gender, education, hobbies, lifestyle, and personal and professional goals. However, coming up with the right personae to use can be challenging. This is particularly so when designing for new markets that are unfamiliar to designers. What are the right customer segments and demographics to cover? What are typical people in these segments really like, on all the dimensions mentioned above? What details should be stated for this representative, though imaginary, person, that are realistic, coherent with the other details, sufficiently representative of the desired sub-population so they do not lead designers astray, yet are not so generic so as to miss the opportunity to drive creative thinking and empathy.

### SUMMARY

According to an exemplary embodiment, market demographic data is segmented into a plurality of market segments using statistical clustering techniques based on demographic descriptions. Each market segment is characterized by a plurality of parameters. Ranges or values are determined for each of the plurality of parameters in a persona template for people in the market segment. Each persona template is associated with a plurality of parameters that characterize the market segment represented by the persona. Specific values of the plurality of parameters are assigned to the persona template that describe a specific, sufficiently representative persona and checks that the specific values of the plurality of parameters are consistent with each other.

Additional functionality can provide increasing levels of rich multi-media information to represent these personae, including images, video and sound, to enable designers, product managers and marketers to more deeply understand the lives represented by the personae and immerse themselves in the context around them.

According to an embodiment of the disclosure, there is provided a computer-implemented method for automatically creating rich personae, including segmenting market demographic data into a plurality of market segments using statistical clustering techniques based on demographic descriptions, where each market segment is characterized by a plurality of parameters, determining ranges or values for each of the plurality of parameters in a persona template for people in the market segment, where each persona template is associated with a plurality of parameters that characterize the market segment represented by the persona, assigning specific values of the plurality of parameters to the persona template that describe a specific, sufficiently representative persona, and checking that the specific values of the plurality of parameters are consistent with each other.

According to a further embodiment of the disclosure, the method includes selecting one or more images, sound clips, and video clips for attachment to the persona template for a market segment, checking that the selected images, sound clips, and video clips do not include details inconsistent with values of other parameters associated with the persona template, and attaching those images, sound clips, and video clips to the persona template that are not inconsistent.

According to a further embodiment of the disclosure, assigning specific values of the plurality of parameters comprises selecting values for each parameter that randomly vary from the average or most prevalent values for that parameter.

According to a further embodiment of the disclosure, the method includes receiving from a user changes to the demographic descriptions used to segment the market demographic data into the plurality of market segments.

According to a further embodiment of the disclosure, the method includes receiving from a user alternative values for any of the plurality of parameters associated with the template persona, and checking that the received alternative values are consistent with other values of the plurality of parameters.

According to a further embodiment of the disclosure, if a received alternative value is inconsistent with another value of one of the plurality of parameters, presenting an indication of the inconsistency to the user, and presenting alternative values that would be consistent.

According to a further embodiment of the disclosure, each market segment is associated with a plurality of persona templates, where each persona template is assigned different specific values of the plurality of parameters, and further comprising presenting the plurality of persona templates to a user, and receiving from the user one or more selected persona templates for the market segment.

According to a further embodiment of the disclosure, the method includes receiving from a user a request to create the rich persona for at one of the plurality of market segments.

According to another embodiment of the disclosure, there is provided a non-transitory program storage device readable by a computer, tangibly embodying a program of instructions executed by the computer to perform the method steps for automatically creating rich personae.

According to another embodiment of the disclosure, there is provided a method of directing advertising to individuals based on a persona, including receiving, by an advertising server, metadata identifying a user from a client device, receiving, by the advertising server, information describing details of the user, where the details correspond to parameters included in personae associated the user's customer segments, selecting a persona that substantially matches the information describing the user, and delivering an advertisement associated with the persona to the client device.

According to a further embodiment of the disclosure, the information describing the user is included in the metadata.

According to a further embodiment of the disclosure, the metadata is used to retrieve the information describing the user from one or more databases.

### BRIEF DESCRIPTION OF THE DRAWINGS

FIG. 1 is a schematic block diagram illustrating an exemplary embodiment of the disclosure.

FIG. 2 is a flow chart of a method of creating rich personae, according to an exemplary embodiment of the disclosure.

FIG. 3 is a flow chart of a method of directing advertising to individuals based on a persona, according to an exemplary embodiment of the disclosure.

FIG. 4 depicts a cloud computing environment according to an embodiment of the present disclosure.

### DETAILED DESCRIPTION

Exemplary embodiments of the disclosure as described herein generally include methods for the creation of rich personae. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure. In addition, it is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

A persona is a model of the desired customer. While the persona depicts a specific person, it is not an actual person. The persona includes different parameters representative of a desired customer's characteristics. The parameters may be determined by interviewing and/or polling customers. Consumer data can be collected from multiple sources to populate the different characteristics of the persona and create a detailed portrait of the desired customer.

A rich persona that captures the details associated with a desired customer may allow a designer to tailor an advertisement or a product to the customer. Software executing on a computer can be used to examine much more information at a greater level of detail than a person and in doing so may create a more detailed persona.

The consumer data can be obtained from different sources. For example, the consumer data can be obtained from survey data, transactional data, behavioral data and demographic data. This consumer data can be obtained in a digital format. A large pool of consumer data may result in a more representative sample of customer information. A computer can be used to collect and examine this large pool of consumer data.

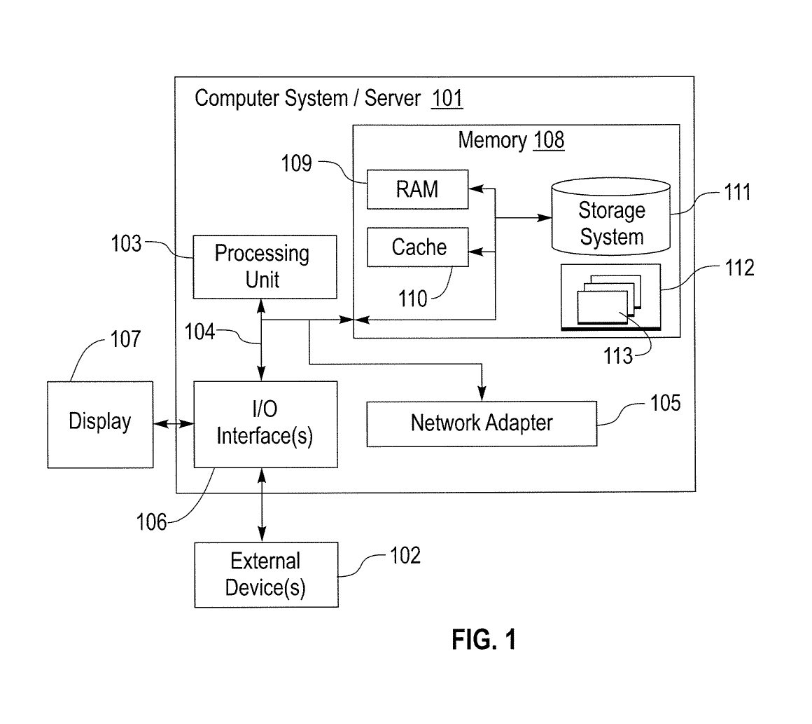

FIG. 1 illustrates an exemplary computer system/server 101 that implements a method for creating rich persona. Computer system/server 101 is illustrative and is not intended to suggest any limitation as to the scope of use or functionality of embodiments of the disclosure described herein.

As shown in FIG. 1, the computer system/server 101 is shown in the form of a general-purpose computing device. The components of the computer system/server 101 may include, but are not limited to, one or more processors or processing units 103, a system memory 108, and a bus 104 that couples various system components including system memory 108 to processor 103.

Bus 104 represents one or more of any of several types of bus structures, including a memory bus or memory controller, a peripheral bus, an accelerated graphics port, and a processor or local bus using any of a variety of bus architectures. By way of example, and not limitation, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus.

The computer system/server 101 may include a variety of computer system readable media. Such media may be any available media accessible by the computer system/server 101, and it includes both volatile and non-volatile media, removable and non-removable media.

The system memory 108 can include computer system readable media in the form of volatile memory, such as random access memory (RAM) 109 and/or cache memory 110. The computer system/server 101 may further include other removable/non-removable, volatile/non-volatile computer system storage media. By way of example, storage system 111 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces. As will be further depicted and described below, memory 108 may include at least one program product having a set (e.g., at least one) of program modules that are configured to carry out the functions of embodiments of the disclosure.

A program/utility 112, having a set (at least one) of program modules 113, may be stored in memory 108 by way of example, and not limitation, as well as an operating system, one or more application programs, other program modules, and program data. Each of the operating system, one or more application programs, other program modules, and program data or some combination thereof, may include an implementation of a networking environment. The program modules 113 generally carry out the functions and/or methodologies of embodiments of the disclosure as described herein.

The computer system/server 101 may also communicate with one or more external devices 102 such as a keyboard, a pointing device, a display 107, etc.; one or more devices that enable a user to interact with the computer system/server 101; and/or any devices (e.g., network card, modem, etc.) that enable the computer system/server 101 to communicate with one or more other computing devices. Such communication can occur via Input/Output (I/O) interfaces 106. The computer system/server 101 can communicate with one or more networks such as a local area network (LAN), a general wide area network (WAN), and/or a public network (e.g., the Internet) via a network adapter 105. As depicted, the network adapter 105 communicates with the other components of computer system/server 101 via the bus 104. It should be understood that although not shown, other hardware and/or software components could be used in conjunction with the computer system/server 101. Examples of these other hardware and/or software components include, but are not limited to: microcode, device drivers, redundant processing units, external disk drive arrays, RAID systems, tape drives, and data archival storage systems.

As will be appreciated by one skilled in the art, embodiments of the present disclosure may be embodied as a system, method or computer program product. Accordingly, embodiments of the present disclosure may take the form of an entirely hardware embodiment, an entirely software embodiment (including firmware, resident software, micro-code, etc.) or an embodiment combining software and hardware embodiments that may all generally be referred to herein as a “circuit,” “module” or “system.” Furthermore, embodiments of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

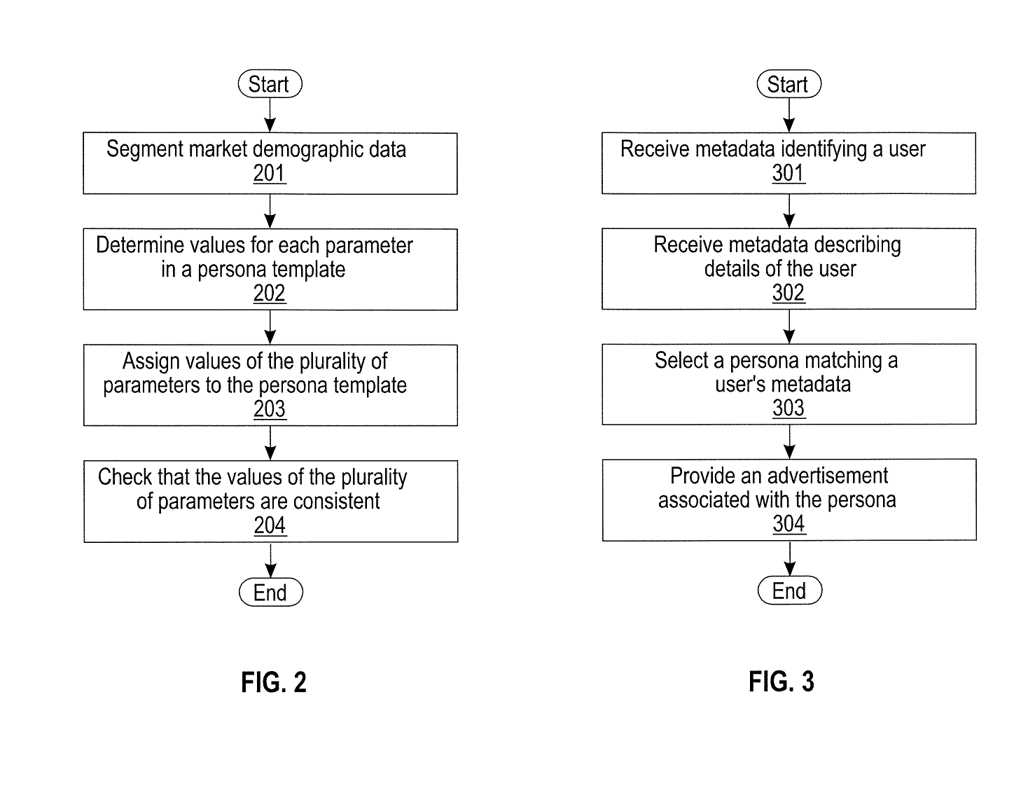

According to an exemplary embodiment, software executing on a processor creates a rich persona. FIG. 2 is a flow chart of a method of creating rich personae, according to an exemplary embodiment of the disclosure. Referring to FIG. 2, a method begins at step 201 by segmenting consumer data into a plurality of market segments using statistical clustering techniques based on demographic descriptions. Each market segment may be characterized by a plurality of parameters. The market segments may be determined objectively through interviews with customers and focus groups or measured quantitatively. The market segments may also be determined quantitatively by examining the consumer data. Quantitative examination of the data may include an independent or a dependent analysis. Independent analysis groups users based on similar characteristics. For example, cluster analysis iteratively maps segments to visualize relationships and spatially cluster variations until a final best fit is identified. For example, the analysis may indicate that gender, entertainment and hobbies are parameters of the desired customer segment. Dependent analysis uses various pattern analysis approaches to identify key market segments from the customer data. Dependent analysis may use neural networks and algorithms such as classification and regression trees and Chi-square based automatic interaction detection. Dependent analysis approaches result in tree-type outputs that are useful graphical representations of segments that can aid in validation.

A user may also suggest terms for use in a market segment. The user may provide feedback to generate market segments including a desired parameter. A user may have one or more desired parameters for the market segment. The user may indicate parameters to include in the market segment. For example, a user may indicate that gender is a desired parameter for a market segment. According to embodiments, statistical methods can be used to generate the market segment as though gender has already been selected as a parameter.

The user may indicate high and low priority parameters for the market segment. The user may indicate that some parameters have a high priority and should be included in the market segment, and that other parameters have a low priority and should not be included in the market segment. For example, the user may want a market segment focusing on gender, age and level of education and may assign these parameters a high priority. The user may assign other parameters a low priority, such as hobbies and homeownership. The different high and low priority parameters can be used to generate a market segment where gender, age and level of education are included and hobbies and homeownership are excluded in the market segment based on the analysis of the customer data. The high priority and low priority designations may also be based on weighted values. A high priority indication may not guarantee that an indicated parameter is chosen but a high priority indication may have a higher likelihood of being chosen than a low priority indication. A low priority indication may have a higher likelihood of being selected than no indication and a lower likelihood of being selected than a high priority indication.

At step 202, ranges or values for each of the plurality of parameters are determined in a persona template for people in the market segment. Each persona template can be associated with a plurality of parameters that characterize the market segment represented by the persona. A persona template may include multiple parameters. For example, the persona template may include age, salary, marital status, hobbies, schools and entertainment activities. Each parameter is assigned a range or a value indicating the likelihood that the parameter represents a desired customer. For example, each of the parameters, such as gender, entertainment and hobbies, are assigned a range or value indicative of the desired customer.

At step 203, specific values of the plurality of parameters are assigned to the persona template that describes a specific, sufficiently representative persona. With a value for each parameter, further details can be specified for the persona. Specific details can be selected from the customer data that meet the required ranges or previously set values. For example, the received customer values may indicate that the desired customer is a woman who likes sports and plays lacrosse.

Specific values of the plurality of parameters are checked for consistency at step 204. Coherence rules and inferences are applied to insure that the persona is consistent. Some combinations of parameter values do not make sense together. For example, if school and courses are determined to be representative parameter values and the specific values chosen are State University and psychology 101, the software determines if State University offers psychology 101 and if not detects an inconsistency. In this situation the inconsistent parameter value may be replaced with a relevant and more consistent parameter value.

In an exemplary embodiment, the personae may be presented to the user as a group or serially. The user may examine the serially presented personae individually until the user selects a persona.

In an exemplary embodiment, the one or more images, sound clips, and video clips are selected for attachment to the persona template for a market segment. A rich persona may include often include more than just values for each of the initial parameters. The addition of relevant multimedia to the persona template provides more detail. The selected images, sound clips, and video clips are checked for inconsistencies with values of other parameters associated with the persona template. The consistent images, sound clips, and video clips are attached to the persona template. For example, the images, sound clips, and video clips can be compared with the selected parameters. If a selected parameter is woman and an image of a man is selected, the image is replaced with an image of a woman. The image of a woman is consistent with the selected parameter.

In an exemplary embodiment, values are selected for each parameter that randomly vary from the average or most prevalent values for that parameter. When selecting a parameter, the most representative parameter may not be selected. Instead, a random value may be selected for the parameter. Selected random parameters may be used in conjunction with multiple personae to create a diverse group of personae.

In an exemplary embodiment, changes to the demographic descriptions used to segment the market demographic data into the plurality of market segments can be received from a user. A user reviews the generated market segments. If a user disagrees with the market segment determinations, the user may alter the market segmentation. For example, if gender, entertainment and hobbies have been determined to be segments for the desired customer, the user may change entertainment to a school the customer attended.

In an exemplary embodiment, alternative values can be received from a user for any of the plurality of parameters associated with the template persona. The user may check the selected parameters. The user may change the parameters to create more diverse personae or to create a more useful persona. After the user rejects a parameter, a new parameter can be selected as a replacement. The replacement parameter may be the next most relevant parameter or a random parameter. The user may also manually add a parameter. For example, a received customer value may indicate that the desired customer is a woman who likes sports and plays lacrosse. If the user is not satisfied with the parameter “plays lacrosse”, the user may choose to reject that parameter and replace the parameter with a new value: “plays softball”. The alternative values are checked for consistency with other values of the plurality of parameters. For example, if school and courses are determined to be representative parameter values, and the value originally chosen for school is State University and the replacement parameter for courses is psychology 101, the software checks if psychology 101 is offered at State University and if not detects an inconsistency. In this situation the inconsistent parameter value may be changed to a relevant and more consistent parameter value.

In an exemplary embodiment, multiple interfaces may be presented to the user to input a replacement parameter. For example, a text field may be presented to enter a replacement parameter. A parameter value of the replacement parameter entered by the user or the replacement parameters prevalent in the customer data may be presented to the user before the user confirms the replacement parameter. A list of replacement parameters may also be presented. The list of replacement parameters may be populated with parameters extracted from the customer data. The list of replacement parameters may be sorted based on how representative each parameter is of a desired customer. An indication of how representative a parameter is of a desired customer can also be displayed.

In an exemplary embodiment, if the user manually replaces a parameter, the user may introduce an inconsistency. If a received alternative value is inconsistent with another value of one of the plurality of parameters, an indication of the inconsistency is presented to the user. An inconsistency check is performed on the manually entered parameter, similar to that described above. For example, if school and courses are determined to be representative parameter values and the value originally chosen for school is State University and the replacement parameter for courses is psychology 101, the software checks if psychology 101 is offered at State University and if not, detects an inconsistency. Alternative values and alternative parameters that are consistent may be presented to the user when an inconsistent parameter is detected. For example, when the persona includes a parameter State University and a user manually enters a parameter “chemistry 101” an inconsistency check is performed. If chemistry 101 is determined to be inconsistent with State University, the user may be presented with a more consistent parameter value.

In an exemplary embodiment, a plurality of persona templates is presented to a user. Customer data is examined to generate a plurality of market segments and create a plurality of persona templates for each market segment. Each persona template may include multiple parameters. The user may review the plurality of persona templates and select one or more templates. The user may select persona templates that represent the most valuable customers or customers that are difficult to design for. The persona template(s) may be selected from a list.

Requests may be received to search or sort the list of persona templates. A server may submit a parameter search and be provided with a list of persona templates that include the parameter, relate to the parameter or metadata about the parameter. For example, a user may search for all the persona templates that include a parameter, such as gender. A search based on metadata may include persona templates generated on a date, for a client or project, or generated using a given statistical algorithm.

A list of personae may be sorted based on the parameter or the metadata. For example, a user may sort a list of persona templates alphabetically based on school attended. Using this view, a user can see which schools customers have attended and which schools are more popular. The user may also request a list of persona sorted based on a date, a client, a project or generated using a given statistical algorithm. An indication of how representative a persona is of a desired customer can also be displayed.

According to an exemplary embodiment, a persona can be used to increase webpage visibility. The parameters used to create a persona may represent relevant search terms for a webpage. The parameters may be added to a webpage by adding additional relevant content to the webpage. Metadata may be added to the webpage to highlight the parameters.

FIG. 3 is a flow chart of a method of directing advertising to individuals based on a persona, according to an exemplary embodiment of the disclosure. Referring to FIG. 3, an advertising server may receive metadata identifying a user from a client device at step 301. The advertising server receives information describing the details of the user at step 302. The information describing the user may be included in the metadata or the metadata may be used to retrieve the information from one or more databases. The details may correspond to parameters included in the personae. A persona is selected that substantially matches the information describing the user at step 303. The advertising server may deliver an advertisement associated with the persona to the client device at step 304. For example, when a user accesses an automatic teller machine ATM, an advertising server may receive metadata about the user from the bank's databases and other electronic sources. The advertising server determines if the user's metadata is associated with a persona and supplies an advertisement associated with the persona to the ATM.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

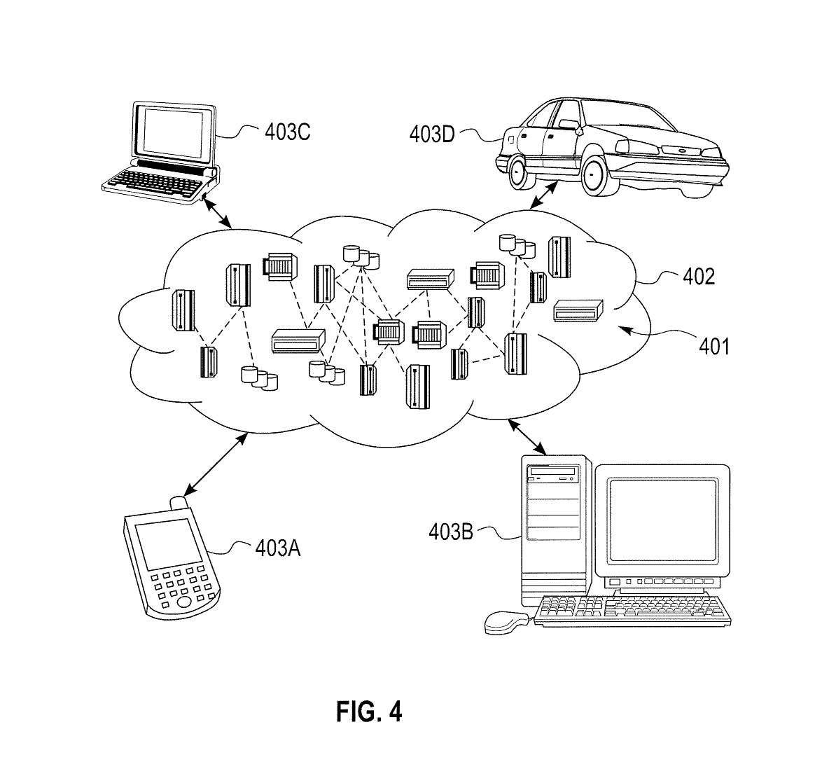

Referring now to FIG. 4, illustrative cloud computing environment 402 is depicted. As shown, cloud computing environment 402 comprises one or more cloud computing nodes 401 with which local computing devices used by cloud consumers, such as, for example, personal digital assistant (PDA) or cellular telephone 403A, desktop computer 403B, laptop computer 403C, and/or automobile computer system 403D may communicate. Nodes 401 may communicate with one another. They may be grouped (not shown) physically or virtually, in one or more networks, such as Private, Community, Public, or Hybrid clouds as described hereinabove, or a combination thereof. This allows cloud computing environment 402 to offer infrastructure, platforms and/or software as services for which a cloud consumer does not need to maintain resources on a local computing device. It is understood that the types of computing devices

403A-N shown in FIG. 4 are intended to be illustrative only and that computing nodes 401 and cloud computing environment 402 can communicate with any type of computerized device over any type of network and/or network addressable connection (e.g., using a web browser).

In an exemplary embodiment, a process for creating a rich persona may be implemented in a cloud environment. For example, consumer data and multimedia data may be stored in a cloud storage and accessed when creating a rich persona. Processing nodes in a cloud environment may also execute software to create a rich persona from the consumer data and the multimedia data.

The flowcharts and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

While embodiments of the disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A computer-implemented method for automatically creating rich personae, the method performed by the computer comprising the steps of:
segmenting market demographic data into a plurality of market segments using statistical clustering techniques based on demographic descriptions, wherein each market segment is characterized by a plurality of parameters;
determining ranges or values for each of the plurality of parameters in a persona template for people in the market segment, wherein each persona template is associated with a plurality of parameters that characterize the market segment represented by the persona;
assigning specific values of the plurality of parameters to the persona template that describe a specific, sufficiently representative persona; and
checking that the specific values of the plurality of parameters are consistent with each other.

2. The method of claim 1, further comprising selecting one or more images, sound clips, and video clips for attachment to the persona template for a market segment, checking that the selected images, sound clips, and video clips do not include details inconsistent with values of other parameters associated with the persona template, and attaching those images, sound clips, and video clips to the persona template that are not inconsistent.

3. The method of claim 1, wherein assigning specific values of the plurality of parameters comprises selecting values for each parameter that randomly vary from the average or most prevalent values for that parameter.

4. The method of claim 1, further comprising receiving from a user changes to the demographic descriptions used to segment the market demographic data into the plurality of market segments.

5. The method of claim 1, further comprising receiving from a user alternative values for any of the plurality of parameters associated with the template persona, and checking that the received alternative values are consistent with other values of the plurality of parameters.

6. The method of claim 5, wherein if a received alternative value is inconsistent with another value of one of the plurality of parameters, presenting an indication of the inconsistency to the user, and presenting alternative values that would be consistent.

7. The method of claim 1, wherein each market segment is associated with a plurality of persona templates, wherein each persona template is assigned different specific values of the plurality of parameters, and further comprising presenting the plurality of persona templates to a user, and receiving from the user one or more selected persona templates for the market segment.

8. The method of claim 1, further comprising receiving from a user a request to create the rich persona for at one of the plurality of market segments.

9. A non-transitory program storage device readable by a computer, tangibly embodying a program of instructions executed by the computer to perform the method steps for automatically creating rich personae, the method comprising the steps of:
segmenting market demographic data into a plurality of market segments using statistical clustering techniques based on demographic descriptions, wherein each market segment is characterized by a plurality of parameters;
determining ranges or values for each of the plurality of parameters in a persona template for people in the market segment, wherein each persona template is associated with a plurality of parameters that characterize the market segment represented by the persona;
assigning specific values of the plurality of parameters to the persona template that describe a specific, sufficiently representative persona; and
checking that the specific values of the plurality of parameters are consistent with each other.

10. The computer readable program storage device of claim 9, the method further comprising selecting one or more images, sound clips, and video clips for attachment to the persona template for a market segment, checking that the selected images, sound clips, and video clips do not include details inconsistent with values of other parameters associated with the persona template, and attaching those images, sound clips, and video clips to the persona template that are not inconsistent.

11. The computer readable program storage device of claim 9, wherein assigning specific values of the plurality of parameters comprises selecting values for each parameter that randomly vary from the average or most prevalent values for that parameter.

12. The computer readable program storage device of claim 9, the method further comprising receiving from a user changes to the demographic descriptions used to segment the market demographic data into the plurality of market segments.

13. The computer readable program storage device of claim 9, the method further comprising receiving from a user alternative values for any of the plurality of parameters associated with the template persona, and checking that the received alternative values are consistent with other values of the plurality of parameters.

14. The computer readable program storage device of claim 13, wherein if a received alternative value is inconsistent with another value of one of the plurality of parameters, presenting an indication of the inconsistency to the user, and presenting alternative values that would be consistent.

15. The computer readable program storage device of claim 9, wherein each market segment is associated with a plurality of persona templates, wherein each persona template is assigned different specific values of the plurality of parameters, and further comprising presenting the plurality of persona templates to a user, and receiving from the user one or more selected persona templates for the market segment.

16. The computer readable program storage device of claim 9, further comprising receiving from a user a request to create the rich persona for at one of the plurality of market segments.

17. A computer-implemented method of directing advertising to individuals based on a persona, comprising the steps of:
receiving, by an advertising server, metadata identifying a user from a client device;
receiving, by the advertising server, information describing details of the user, wherein the details correspond to parameters included in personae associated the user's customer segments;
selecting a persona that substantially matches the information describing the user; and
delivering an advertisement associated with the persona to the client device.

18. The method of claim 17, wherein the information describing the user is included in the metadata.

19. The method of claim 17, wherein the metadata is used to retrieve the information describing the user from one or more databases.
